(19) United States
(12) Patent Application Publication
(10) Pub. No.: US 2012/0271647 A1
(43) Pub. Date: Oct. 25, 2012

(54) METHOD FOR IMPROVED ADHERENCE TO MEDICATION THERAPY

(75) Inventors: Dimitri G. Betses, Merrimack, NH (US); Sidharth S. Sahni, North Attleboro, MA (US); Christopher L. Cox, Needham, MA (US); Timothy A. Ducharme, Cumberland, RI (US)

(73) Assignee: CVS Pharmacy, Inc., Woonsocket, RI (US)

(21) Appl. No.: 13/090,946

(22) Filed: Apr. 20, 2011

(51) Int. Cl. G06Q 50/00; G06Q 10/00

(52) U.S. Cl. 705/2

(57) ABSTRACT

A method for improved adherence to a medication therapy by providing patient interventions at clinically relevant times is disclosed. A pharmacy receives and stores patient information and prescription information in one or more databases, and then fills a prescription for a patient based on the patient information. The pharmacy identifies a plurality of adherence interventions and provides a first-fill counseling session to the patient when the patient receives the filled prescription. The pharmacy also provides a first fill follow-up session and adherence outreach at clinically relevant times.

### FIELD OF THE INVENTION

The disclosed invention relates to a method for improved adherence to a medication therapy. More specifically, the disclosed invention relates to a series of interventions by a pharmacy at clinically relevant times to encourage patient adherence to a medication therapy.

### BACKGROUND OF THE INVENTION

Lack of adherence to a medication therapy poses significant challenges to patients and the healthcare industry in the United States. Presently, one in three patients who start a maintenance prescription will decide to discontinue treatment before their first refill is due and more than three out of every four patients will stop their medication within the first year. Moreover, less than half of patients take their doses as prescribed. Approximately one out of ten hospital admissions and nearly one out of every four nursing home admissions are due to non-adherence to medication therapy. Despite these staggering figures, nearly two-thirds of patients are still not educated by their physicians on how long they are supposed to remain on a new medication therapy leading to almost $300 billion in annual healthcare costs.

Though influenced by several factors, a patient's failure to adhere to a medication therapy may be caused by the patient's failure to initially fill a prescription. Until the patient fills a prescription, the patient is not able to begin a medication therapy, much less adhere to a medication therapy.

Another problem leading to failure to adhere to medication therapy is the patient's lack of understanding of medication-specific information at the outset of the therapy. For example, patients may confuse the lack of feeling differently for a total lack of efficacy, which may lead to non-adherence. Additionally, for example, a patient may suffer from initial side effects due to the start of treatment, which may lead to non-adherence to a medication therapy as prescribed by their physicians.

Another problem leading to failure to adhere to medication therapy is the patient's lack of refilling a prescription. This may be caused by a perceived completion of the medication therapy, inability to afford the prescribed medication, or simple forgetfulness.

Various methods and systems for adherence to a medication therapy have been implemented in an attempt to address a patient's failures to adhere to a medication therapy. For example, there exist methods and systems that provide reminders and alerts for taking medication and for refilling prescriptions. These methods and systems have failed largely because of over-reliance on technology to solve the adherence problem, and a lack personal interaction between a medical professional with the patient at clinically relevant times.

Increasing a medically trained professional's interaction with the patient at clinically relevant times educates the patient and facilitates adherence with the patient's medication therapy. However, unstructured patient contact may prove to be unproductive, serving to harass the patient and wasting both the patient's and the pharmacy's time and money.

Therefore, a need exists for a method for improved adherence to medication therapy.

### SUMMARY OF THE INVENTION

Accordingly, it is an object of this invention to provide a method for improved adherence to a medication therapy providing patient intervention at clinically relevant times. The present invention comprises a patient information database that stores patients' relevant medical information, contact information, and prescription information. The pharmacy, through, for example a pharmacist or pharmacy technician, may access the patient information database to update or receive patient information in order to determine the mode and clinically relevant time to contact the patient. In this manner, the disclosed method combines an appropriate use of back-end technology with targeted in-person and over-the-phone interactions to provide a series of coordinated patient interventions during a patient's continuum of care that vary in frequency and intensity based upon published patient behavior patterns, proprietary patient adherence models, and ability to incorporate each patient's unique activities.

According to an embodiment of the disclosed method, the pharmacy receives patient information prior to filling the prescription, and then stores such patient information in one or more databases. The patient information may include information such as patient name, age, prescription information, contact information and preferred contact method. The patient's prescription is filled by the pharmacy based on the patient information stored in the database.

According to an embodiment, the pharmacy provides a first fill counseling session where the patient receives information specific to the medication such as initial efficacy, interaction with other medication, or side effects caused by the prescribed medication. In some embodiments, the first-fill counseling session is conducted by a pharmacist with the patient at the time that the patient fills the first prescription. Additionally, the database may be updated with information provided by the patient during the first-fill counseling session.

According to an embodiment, the patient identified as potentially non-adherent and is contacted by the pharmacy in a first-fill follow-up at a clinically relevant time. The first-fill follow-up serves in part to convey medication-specific information, reinforce the information provided in the first-fill counseling session, and promote increased adherence to a medication therapy. In the event that a prescription is filled but not received by the patient, the pharmacy will contact the patient.

Also according to an embodiment of the disclosed method, the pharmacy also provides a fill reminder at a clinically relevant time prior to the next fill required in a medication therapy. Additionally, the pharmacy may also provide an adherence outreach session where the patient is contacted after a prescription fill has occurred.

An advantage of the disclosed method is the ability to improve patient adherence to medication therapy by using a combination of technology and in-person or over-the-phone interactions to provide a series of coordinated patient interventions during a patient's continuum of care. The disclosed method has been demonstrated to provide a 550 basis point (bps) improvement in patient adherence for selected drug classes over a control group. Furthermore, the disclosed method has been demonstrated to provide a 390 bps improvement over the current industry-leading adherence program among chain pharmacy retailers. Moreover, when compared to the current adherence programs of three other chain pharmacy retailers, the disclosed method has been demonstrated to provide an average improvement in patient adherence of 400 bps for diabetes medications, 650 bps for hypertension medications, and 430 bps for depression medications.

### BRIEF DESCRIPTION OF THE FIGURES

FIG. 1 is a schematic of a patient database for use in an embodiment of the present invention.

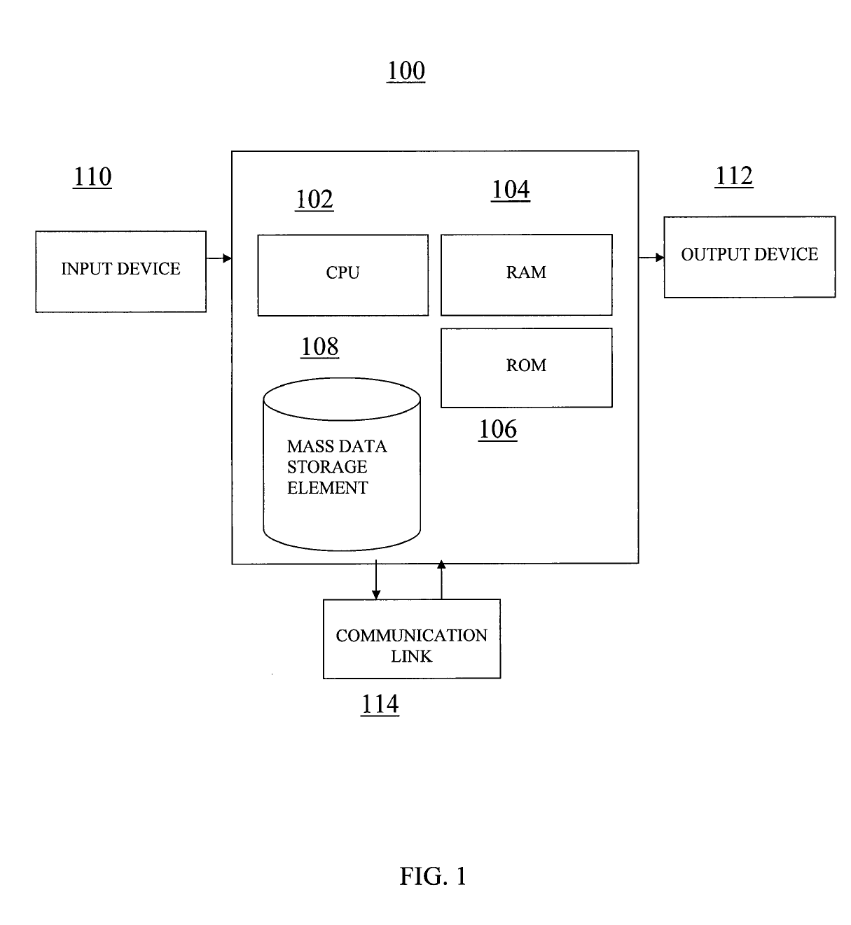

FIG. 2 is an overview a method for improved adherence to a medication therapy providing patient intervention at clinically relevant times in accordance with a preferred embodiment and best mode of the present invention.

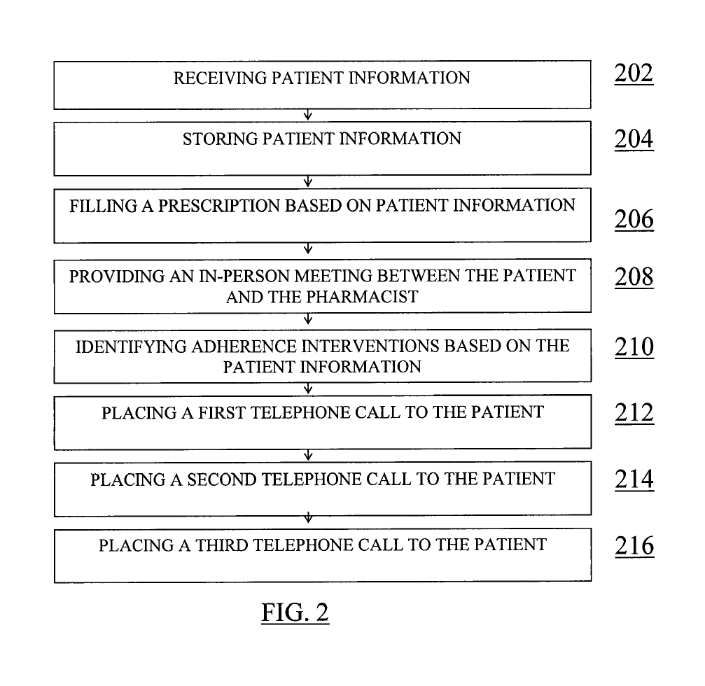

### DETAILED DESCRIPTION OF PREFERRED EMBODIMENTS

Patient Information Database

Prior to filling the prescription, the pharmacy receives patient information. The patient information preferably includes the patient's relevant medical and contact information, such as name, age, prescription information, phone number, home address, e-mail address, emergency contact information, preferred contact method, and physician information. The pharmacy stores such patient information in one or more databases 100.

The database 100 for storing the patient information may be located at the pharmacy or in a remote location. The database 100 may comprise a central processing unit (CPU) 102, random access memory (RAM) 104, read-only memory (ROM) 106, one or more mass data storage elements 108, an input device 110, an output device 112, and a communications link 114. The mass data storage element 108 may be comprised of a combination of magnetic, optical and/or semiconductor memory. The input device 110 may include a keyboard, a mouse, a touch screen, or other types and/or combinations of data entry devices. The output device 112 may include a display such as a computer monitor, a printer, or other types and/or combinations of data display devices. Software may be stored in the RAM 104, ROM 108, or other memory in the database 100. The software may include operating system software, application software, or other software to control the database 100. In one example, the database 100 may be an Oracle database stored on hardware from EMC Corporation or IBM that runs a UNIX operating system.

The pharmacy can access the database via the communications link 114, whether the database 100 is located locally or remotely. Additionally, the pharmacy can access the database 100 from a point-of-sale location, from a corporate location, or other remote location. The communications link 114 may be a local area network (LAN), wide area network (WAN), or the Internet through a variety of connections such as standard telephone lines, wireless networks, broadband connections, or some combination of any or all of the above. Because the pharmacy may have more than one location, the database with the patient information should be accessible via the communications link 114 to the various locations of the pharmacies, various points-of-sale, or other remote locations. As such, the various locations of the pharmacies may have the capability to transmit and receive information to the database via the communications link 114.

First-Fill Counseling

In an embodiment of the first-fill counseling session, the patient is provided medication-specific information including initial efficacy, drug-drug interaction, or side effects caused by the medication therapy. The patient may also be provided with some of the common root causes of non-adherence, solutions to adherence barriers, and information specifically tailored to their condition and medication therapy. Additionally, the patient may be provided with a set of informational documents that explain the particular medication therapy and some of the causes and remedies to non-adherence. Also during the first-fill counseling session, the pharmacy may confirm the patient's relevant medical information, which may include name, address, contact information, age, height, current medication, health condition, or other information. Moreover, the pharmacy may update the database 100 with patient information provided by the patient at the time of the first-fill counseling session.

In a preferred embodiment, a pharmacist provides a first-fill counseling session to the patient by way of a face-to-face conversation at the time of the first fill of the prescription. The first-fill counseling session may address information such as recommended dosage, indicated treatment, side effects, drug-drug interaction, or other information. In an alternative embodiment, a pharmacy technician engages the patient in a first-fill counseling face-to-face conversation regarding the medication therapy and the patient's relevant medical information. The patient's relevant medical information may include name, address, contact information, age, height, current medication, health condition, or other information.

Identify Potentially Non-Adherent Patients

In an embodiment of the disclosed method, the pharmacy will identify patients as potentially non-adherent based on information stored in the database 100. In addition to storing patient information, the database 100 can also contain information on various medication therapies including probabilities of non-adherence for combinations of patient types and medications. Such information may be based on research conducted by the pharmacy, results of studies conducted by third-party organizations, or other public or private information. For example, patients may be identified as at risk for non-adherence to a medication therapy because of the particular type of medication prescribed, the number of refills required for adherence, time since previous fill, or the specific age and condition of the patient. In another embodiment of the disclosed method, the pharmacy will identify patients as potentially non-adherent independent of the medication therapy or the patient's relevant medical information.

Prescription Fill Follow-Up

In an embodiment of the prescription fill follow-up, the patient is contacted at a clinically relevant time to reinforce the importance of continuing therapy after the patient receives a filled prescription from the pharmacy. The pharmacy may contact the patient via the patient's preferred method of contact based on the patient's information in the database 100. In an embodiment of the disclosed method, a pharmacist provides medication-specific information to the patient and addresses patient-specific information. The clinical relevance of the time to contact the patient may be dependent on specific medication regimens, the side effects of particular medications, the initial efficacy of the medication therapy, or any combination of similar variables. The clinical relevance of the time to contact the patient may also be dependent on patient-specific information such as the fill number of the prescription, patient information in the database 100, or other similar variables. In a preferred embodiment, a pharmacist places a telephone call to the patient after the patient receives the filled prescription to provide medication-specific information and address any patient-specific issues. The prescription fill follow-up may occur after the first fill of the prescription, after the first few fills of the prescription, or after every fill of the prescription.

In the event that the patient does not receive the filled prescription, the pharmacy may contact the patient at a clinically relevant time to reinforce the importance of starting or continuing therapy. In a preferred embodiment, a pharmacist would place a telephone call to the patient between three (3) to ten (10) days after the prescription is filled in the event the patient does not receive the prescription.

Adherence Outreach

In an embodiment of the adherence outreach, the pharmacy contacts the patient at a clinically relevant time such as a potentially critical drop-off point in the course of the medication therapy. For example, the adherence outreach provides reinforcement of the importance of continuing therapy, medication-specific information to the patient, as well as reminders to patients when prescriptions are due or are overdue. The clinical relevance of the time to contact the patient is determined by the information stored in the database such as the patient information, the medication therapy, the results of studies, tests or trials, or other information stored in the database 100. The adherence outreach may consist of a plurality of telephone calls to the patient throughout the course of the medication therapy to improve adherence and compliance with a medication therapy.

In a preferred embodiment of the adherence outreach, a pharmacy technician places a telephone call to the patient in order to address patient-specific issues at a clinically relevant time that is dependent on the specific medication. During this contact with the patient, the pharmacy technician may additionally encourage the patient to opt into a refill program, which automatically fills prescriptions when due and informs the patient when the prescriptions are ready to be picked up. Thus, patients can take advantage of a convenience to adhere to a medication therapy. Approximately three (3) to seven (7) days prior to the refill date, the patient is contacted by an Interactive Voice Response (IVR) system to prompt the patient for a refill when it is due. The IVR system is an automated telephone system that provides information to the patient by making a telephone call to the patient, providing a pre-recorded message, prompting the patient for information, presenting the patient with a set of options, and recording information provided by the patient. In one example, the IVR system is implemented by a Microsoft SQL Server database operating Microsoft Windows software in conjunction with a switch from Sonus Networks to initiate the telephone call to the patient, Voice XML for scripting, and software from Nuance Communications, Inc. for text-to-speech functionality.

The IVR system may communicate with the patient information database 100 either directly or indirectly. In the event the refill becomes overdue, a pharmacist or pharmacy technician places a telephone call to the patient less than thirty (30) days after the prescription becomes past due for a refill and provides the patient with information on the importance of adherence with the medical therapy and encourage refill of the prescription.

While the preferred embodiments of the present invention have been described above, it should be understood that they have been presented by way of example only, and not of limitation. It will be seen that the techniques described herein provide a basis for improved adherence to medication therapy. It will be apparent to persons skilled in the relevant art that various changes in form and detail can be made therein without departing from the spirit and scope of the invention. Thus, the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A method for managing medication adherence of a patient, comprising the steps of:
receiving patient information comprising patient name, telephone number, and prescription information;
storing the patient information in one or more databases;
filling a prescription for the patient based on the patient information;
identifying adherence interventions based on the patient information;
providing an in-person counseling session between the patient and a pharmacist when the patient receives the filled prescription;
placing a first telephone call to the patient after the patient receives the filled prescription;
placing a second telephone call to the patient prior to the day that the prescription is due for a refill; and
placing a third telephone call to the patient in the event the prescription is past due for a refill.

2. The method of claim 1 further comprising the step of having a pharmacist place an initial telephone call to the patient after the prescription is filled and before the patient receives the filled prescription.

3. The method of claim 2 where placing the initial telephone call to the patient is between three (3) and ten (10) days after the prescription is filled.

4. The method of claim 1 where placing the first telephone call is at a time that is dependent on the medication the patient is prescribed.

5. The method of claim 1 where the first telephone call to the patient is placed by a pharmacist.

6. The method of claim 1 where the first telephone call is placed by a pharmacy technician.

7. The method of claim 1 where placing the second telephone call is between three (3) to seven (7) days prior to the date the refill is due.

8. The method of claim 1 where the second telephone call is placed by a pharmacy technician.

9. The method of claim 1 where the second telephone call is placed by an interactive voice response system.

10. The method of claim 1 where placing the third telephone call is less than thirty (30) days after the prescription becomes past due for a refill.

11. The method of claim 1 where the third telephone call is placed by a pharmacist.
